(19) United States
(12) Patent Application Publication
(10) Pub. No.: US 2009/0263220 A1
(43) Pub. Date: Oct. 22, 2009

(54) Motorcycle carriers

(76) Inventor: Robert Miller, Huntington Beach, CA (US)

Correspondence Address: I. Michael Bak-Boychuk;Attorney at Law, P.O. Box 32501, Long Beach, CA, 90832, US

(21) Appl. No.: 12/384,630

(22) Filed: Apr. 8, 2009

Related U.S. Application Data
(60) Provisional application No. 61/125,084, filed on Apr. 22, 2008.

(51) Int. Cl. B60P 1/14

(52) U.S. Cl. 414/478; 414/480; 414/489

(57) ABSTRACT

A deployable set of nested ramp segments supporting a motorcycle thereon are sequentially extended or pulled in across the door edge in a carrier vehicle by sets of springs that oppose the spooling collection of a belt wound on a powered spool. Once partly extended by the springs to bring the main portion of the motorcycle to the exterior of the vehicle doorway the weight bias of the motorcycle then provides the necessary outward bias to bring it to the ground where it is released from the supporting ramp segment. On return the spooling contraction of the belt brings the motorcycle back into the vehicle.

### BACKGROUND OF THE INVENTION

1. Reference to Related Applications

This application obtains the benefit of the earlier filing date of U.S. Provisional Application Ser. No. 61/125,084 filed on Apr. 22, 2008.

2. Field of the Invention

The present invention relates to motorcycle carriers, and more particularly to vehicle borne articulated carrier structures useful in lifting and moving a motorcycle mounted thereon into and out of an enclosed motor vehicle such as a van or a sports utility vehicle.

3. Description of the Prior Art

Motorcycle carriers have been known in the past, most often taking the form of an articulated ramp which in the course of its movement either raises or lowers a motorcycle mounted and secured thereon on top of or down from an open bed of a motor vehicle. Examples of such carriers may be found in the teachings of U.S. Pat. No. 6,695,565 issued to Franchuk; U.S. Pat. No. 6,698,994 issued to Barrett; U.S. Pat. No. 6,524,056 issued to Kloster; U.S. Pat. No. 6,634,849 issued to Clary; U.S. Pat. No. 6,739,823 issued to Shirvell; the U.S. Pat. Nos. 4,790,713 and 4,932,829 issued to me; and others. In each of these references the motorcycle is carried on the vehicle bed fully exposed to the elements and/or to vandalism or theft when left unattended.

The transport of a motorcycle within the enclosed interior of a sports utility vehicle [SUV] or a van has had lesser attention in the prior art because of the limiting customary dimensions of its access openings and/or the volumetric limits of the interior enclosure. For these reasons the size of the transported article needs to be limited, as for example the size limitations of a service cart transported in the interior of a van exemplified in U.S. Pat. No. 5,183,372 issued to Dinvemo. Alternatively, a specially altered vehicle needs to be used, as in U.S. Pat. No. 5,649,803 issued to Bennett in which only a van modified to carry a wheel chair has been found useful for transporting motorcycles.

Simply, those in the prior art has concluded that there are prohibiting dimensional constraints, as even expressly stated in the '803 patent to Bennett, between the structural height of the deployable ramp mechanism together with the motorcycle mounted vertically thereon and the typical dimensions of the access door and the interior dimensions of the enclosure. As result there have been few attempts at achieving a solution resolving this dilemma.

In the past I have disclosed in my published US application 2005/0111945 an articulated ramp assembly useful in deploying and retrieving a wheeled dolly for launching a personal water craft carried on a truck bed. Even in these related arts dealing with the transport of fairly fragile and expensive articles little hope and ambition were ascribed for such transport within the confines of a closed van or sports utility vehicle [SUV]. Simply, it is the perceived dimensional paradox resulting from the needed vertical height and lateral width of the necessary frame around any door opening that has effectively precluded any significant developments in these arts.

Of course, the need for a robust frame surrounding a door is a known requirement, particularly where light-weight monocoque or semi-monocoque structures are entailed. But then, efficient use of power demands a light weight in a transport vehicle and at least a semi-monocoque vehicle form is now the standard. At the same time venerable habits and conventions, like the size of an attached garage, have limited the dimensional notions of vehicles conformed for personal use as do bridges driveways, gates and the like. Thus it is only the coordinated movement of the ramp articulating mechanism that can resolve this structural and dimensional paradox and it is one such mechanism that is disclosed herein.

### SUMMARY OF THE INVENTION

Accordingly, it is the general purpose and object of the present invention to provide a trolley support for a nested array of telescoping ramp segments that advances the end thereof to the sill of the door opening in order to define the principal maneuvering pivot and balance fulcrum thereat.

Other objects of the invention are to provide a transport mechanism for a nested and articulated deployable ramp assembly that aligns its weight balances and pivotal axes at the threshold of a vehicle door opening.

Yet other and further objects shall become apparent in the course of inspection of the detailed teaching and illustrations below.

Other and further objects will become apparent upon review of the specification that follows in conjunction with the drawings appended hereto.

Briefly, these and other objects are accomplished within the present invention by way of a spring biased rolling trolley assembly mounted on a set of tracks fixed to the floor of the van or SUV to be drawn by the spring tension to the track end abutting against the lower frame piece of the rear door opening against the tension of a belt tied to a nested ramp assembly mounted on the trolley. In this manner the ramp assembly is allowed to translate within the vehicle interior to extend the end of its lowest ramp piece over the door sill as the deployment belt is spooled out, thereby providing a fulcrum right beyond the door edge around which the various weight balances can be resolved as the further portions of the ramp mechanism is extended. In this manner the alignment of the motorcycle can be conveniently modified right in the course of its passage through the door opening to capitalize on the variation in height along its length.

To take benefit of this door opening alignment the ramp assembly is configured as a set of nested ramp channels generally similar to the nested arrangement described in my previously published US application 2005/0111945 [hereinafter referred to as the '945 application] the teachings whereof I now incorporate as if fully repeated herein. While generally similar in its nested nature the instant ramp mechanism includes a plurality of selective travel and pivotal alignment limits of the trolley relative its track, the lower ramp segment relative the trolley and the upper motorcycle carrier segment so that variously sized vehicle interiors and openings together with variously sized motorcycles can be accommodated and it is these teachings that are set out herein.

More precisely, both the outward and pivotal excursion of the trolley along its track and its upward tilting about its rollers in response to the weight balance shifts during its outward translation allowed by the release of the spooled belt, are limited by a set of selectable limits. Similarly, the relative movement between the lower ramp segment and the trolley, urged by the spring bias of a second set of springs between the trolley and the segment, is also limited in its rolling translation by selective deployment of a set of limit posts within outwardly opposed lateral channels in which a pair of end rollers on the trolley are captured. The pivotal inclination of the lower segment, in turn, is controlled by a further pair of lateral rollers on the sides of the lower ramp segment as they advance along the vertically shaped edges of the trolley.

This whole sequence is controlled by the spooled release of the belt extending its end that is tied to the nested inner carrier segment with the motorcycle thereon fitted for outward sliding translation within the lower segment from a limit stop in its forward end. The spring urged and thereafter weight unbalance driven movement of the lower segment is thus confined to occur first, thereby assuring that its extension movement clears the door frame before the carrier segment is released to roll onto the ground. In this manner the geometric relationship of the several relatively moving components assures the optimization of the stored geometry within a mechanism that locates all its movements by reference to the door opening, thus fixing the whole movement geometry to the most confining dimension.

### BRIEF DESCRIPTION OF THE DRAWINGS

FIG. 1 is a perspective illustration, separated by parts, of my prior art carrier structure useful in loading onto, and unloading from, a water craft on a transport vehicle;

FIG. 2 is a perspective view of the inventive motorcycle carrier assembly currently described in its partially extended alignment from an enclosed transport vehicle;

FIG. 3 is a further perspective illustration of the inventive motorcycle carrier assembly in a substantially advanced state of its outward deployment out of the door opening of said transport vehicle; and

FIG. 4 is a rear angle view, in perspective, illustrating the end portions of the outward deployment of the inventive motorcycle carrier.

### DESCRIPTION OF THE PREFERRED EMBODIMENT

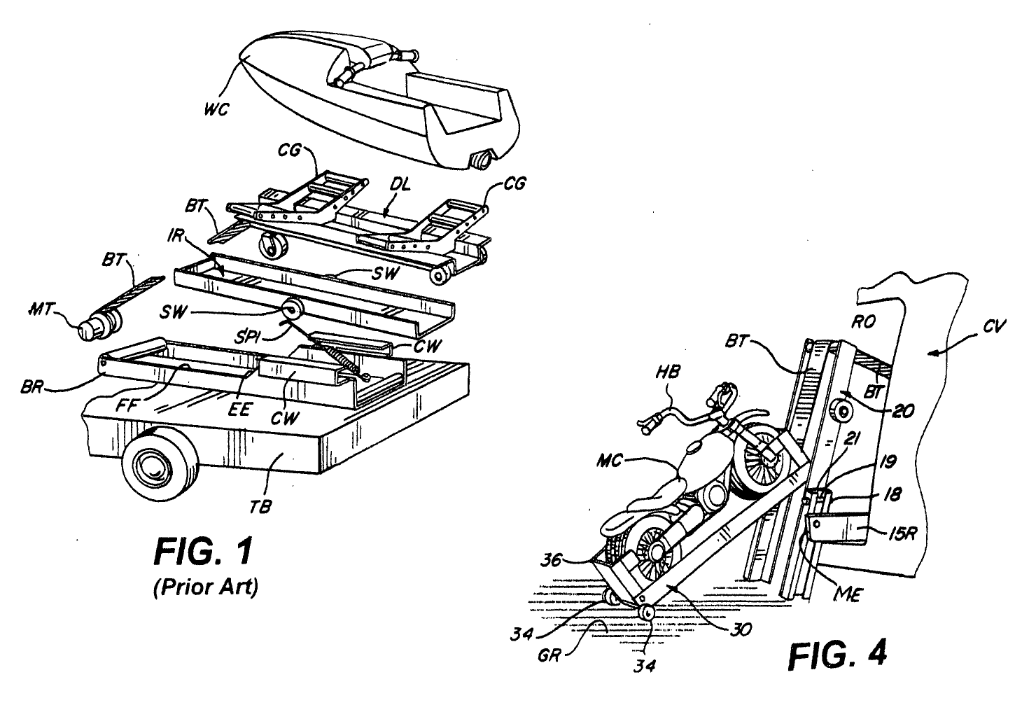

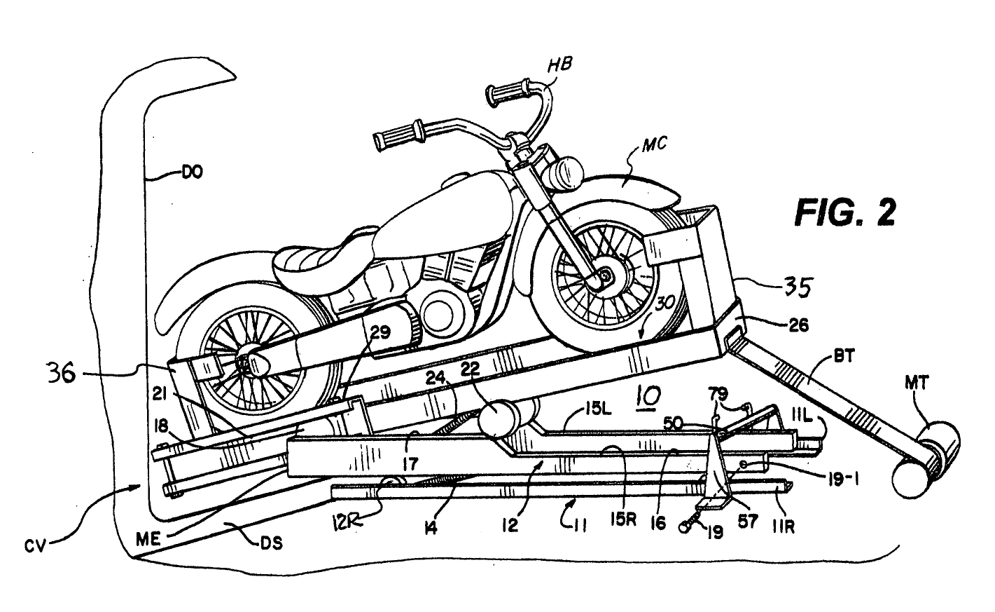

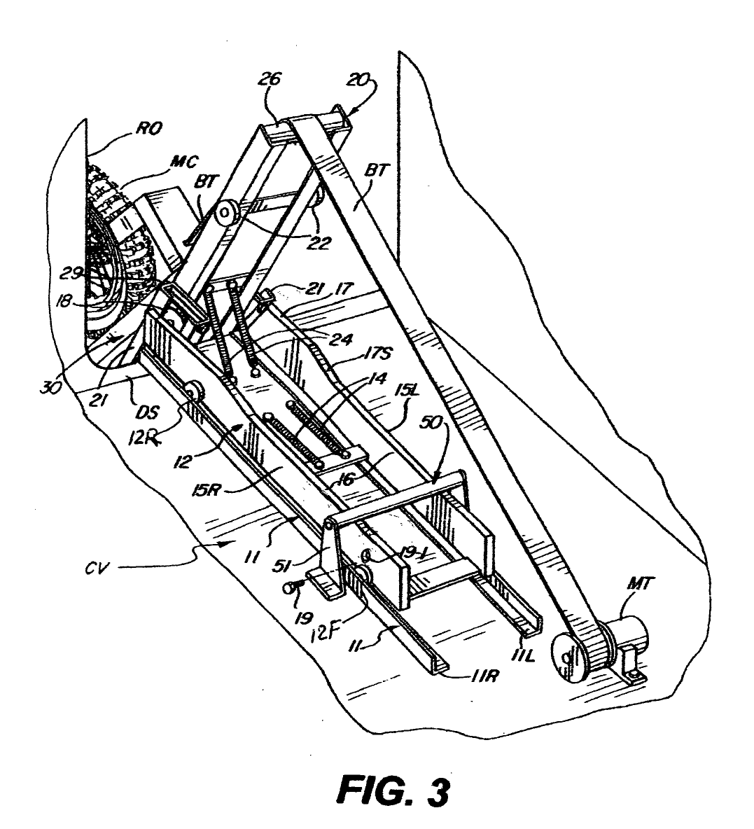

Articulated ramp assemblies have been known in the past usually conformed as a lifting structure for moving one vehicle onto and from another. Included in the various examples thereof is the articulated ramp assembly disclosed in my prior '945 published application which both loads and unloads for launching a personal watercraft the teaching whereof I now summarize by particular reference to FIG. 1. In each instance the primary focus of these prior teachings has been the coherent articulations of the various portions of the ramp assembly relative each other in order to minimize loading and the like but little attention has been directed to the task of in the tight dimensional confinements of a doorway in an enclosed transport structure.

For example, by reference once more to the structure illustrated in FIG. 1 my prior art teachings useful in transporting personal watercraft WC includes a ramp assembly generally designated RA defined by a bottom ramp segment BR mounted on a truck bed TB in which an intermediate ramp segment IR is nested and supported on laterally spaced wheels SW for rolling translation on the lateral edges FF of the base segment. A tensioned spring SP1 stretched between the base segment BR and the intermediate segment IR then provides an outwardly directed spring bias to the inner segment against the tension provided by a spooled belt BT paid out from a motorized spool assembly MT. A roller supported dolly DL tied to the end of belt BT and nested in the intermediate segment IR against a front stop FT is then useful to support the watercraft WC within cradles CG both during transport on the truck bed TB and once lowered onto the ground.

In order to provide a pivoting weight bias once translated to a particular point along the edges FF of base segment BR a set of upwardly sloped portions EE which limit all further outward translation until the pivotal motion removes the slope EE and thereafter directs the rollers SW into a captured receipt within a pair of channels CW closed at the end of the segment. It is only once these limits are reached that the unsupported weight bias of the dolly assembly results in further pivotal movement until the dolly reaches the ground. Thus in this arrangement the transported article, i.e., the water craft WC, is first lifted before it is pivoted, a movement wholly inconsistent with the usual dimensional limits of a door opening.

By reference to FIGS. 24 the inventive ramp assembly, generally designated by the numeral 10, includes a rolling track 11 defined by left and right tracks 11L and 11R extending longitudinally towards the rear door opening RO of the closed vehicle CV from a motorized spool MT from which a belt BT is paid out Preferably the spool MT is mounted adjacent to or between the front seating to maximize the available interior volume within which the motorcycle MC is contained A trolley frame 12 supported on front and rear rollers 12F and 12R is then mounted for translation on the on track 11, biased towards rearward movement by a spring assembly 14 to extend its rear end ME beyond the door sill frame portion DS of the rear door opening DO in the enclosed transport vehicle CV.

Laterally trolley 12 is provided with a right and left vertical side panel 15R and 15L each including a stepped upper edge defined by a straight forward edge portion 16 and a raised rear edge portion 17 joined by a slanted edge segment 17S. At the rear end ME both the right and left side panels 15R and 15L each include inwardly deployed support wheels 18 respectively captured within the interiors of slotted side channels 21 fixed on the opposing exterior end portions of an intermediate channel segment 20 which at its forward lateral surfaces deploys a pair of rollers 22 aligned for rolling contact along and against the edge portions 16 and 17 and the slanted connecting edge segment 17S thereby supporting the forward weight portion of the intermediate channel segment 20 with the carrier ramp segment 30.having the motorcycle MC mounted thereon nested in segment 20.

Yet another spring assembly 24 stretched between trolley 12 and channel segment 20 also imposes an outward spring bias thereto to complement the outward bias of spring 14 on the trolley 12 which provides its rolling support These combined outward biasing forces are, in turn, opposed by the connection of belt BT to the carrier ramp channel segment 30 confining the motorcycle with this opposing force then transferred to segment 20 by a stop panel 26 extending across the front of the segment. Thus both the spring assemblies 14 and 24 urge the motorcycle out the vehicle door when the motorized spool MT is released.

The stroke of the outwardly biased movement of the trolley is determined by the selective insertion of a stop pin 19 into the corresponding openings 19-1 in both the lateral panels 15R and 15L to engage the vertical supports 51 of a roller assembly 50 bridging across track 11 on which the trolley rests when fully retracted. Similarly, the movement range of segment 20 relative the trolley is determined by the limits of motion of the rollers 18 respectively captured within the interiors of the slotted side channels 21 fixed on the opposing exterior end portions of an intermediate channel segment 20 which at its a limit again determined by the selective insertion of a limit pin 29 spanning transversely the channel.

When these limits are reached, the resulting weight and geometry will allow rotation of segment 20 and the cantilevered deployment of the carrier segment 30 with the motorcycle fixed thereon. However, as segment 20 approaches its rear limit the center of gravity of the resulting combination will then be to the rear of the rear rollers 12R of the trolley 12, lifting the forward end of the trolley to engage the underside of the transverse roller 50. A pair of stop post 79extending from the lateral walls 1 5L and 15R are then to the rear of the transverse roller 50 and the combined weight then restrains the trolley in this interlocked position until the subsequent retrieval process moves the center of gravity of the combined translating assembly once again forward of the rear rollers 12R.

During the deployment segment 30 is lowered by its own weight in response to further unwinding of the spooled belt BT until the rear set of rollers 34 contact the ground GR. At this point the further unwinding of the belt BT results in the rearward translation of rollers 34, lowering the carrier 30 to the ground. Once fully lowered onto the ground surface GR the front and rear retaining assemblies 35 and 36 are disengaged to release the motorcycle from the carrier. Of course, the reverse of this same sequence is then useful to retrieve the motorcycle back into the vehicle CV in the retraction sequence effecting the weight biases described above.

It will be appreciated that the restraining brackets 35 and 36 may be variously implemented and may include conventional structures like turnbuckles to compress the suspension height of the motorcycle MC to fit into the door opening. Examples of such restraining structures are described in my co-pending U.S. patent application Serial No. 12/231,267 filed on Sep. 2, 2008 and those prior art references considered therein.

Those skilled in the art will appreciate that the usual configuration of the motorcycle MC has its highest dimension at its handlebars HB. These same conventional practices, however, also rake the handlebar HB rearwardly, with the resulting rearward shift in the maximum height by aligning the effective pivot center right outside the rear opening RO. These dimensional attributes are inventively optimized here, optimizing the dimensional solution of the paradox inherent in loading a motorcycle through the limited dimensions of a vehicle door further improved by tensioning the tie-downs to compress the suspension height which also limits the unwanted motorcycle motions during transport.

Obviously many modifications and variations of the instant invention can be effected without departing from the spirit of the teachings herein. It is therefore intended that the scope of the invention be determined solely by the claims appended hereto.

It is claimed:

1. A deployable structure useful in moving a motorcycle mounted on a ramp through a doorway of a motor vehicle, comprising:
a source of rotary power deployed in said vehicle and provided with a spool assembly having a flexible connecting member wound thereon having its free end connected to said ramp;
a rolling track mounted generally longitudinally in said vehicle having one end thereof aligned adjacent said spool assembly and the other end aligned towards the lower edge of said doorway and including a first urging means operatively connected between said rolling rack and said vehicle, for urging said other end adjacent said lower edge;
a first rolling segment mounted for rolling translation on said track said first rolling segment including a first and a second end and second urging means operatively connected between said rolling rack and said first segment for the advancement thereof relative said rack to extend said second end beyond said lower edge of said doorway; and
a second rolling segment mounted for rolling translation between the first and second ends of said first rolling segment and for supporting said ramp thereon

2. A deployable structure according to claim 1, wherein:
said first and second urging means each include a spring.

3. A deployable structure according to claim 2, wherein:
said first rolling rack includes a set of end rollers at said other end.

4. A deployable structure according to claim 3 wherein:
said first rolling segment includes engagement means conformed to capture said end rollers upon the translation thereof to said other end.

5. A deployable structure according to claim 1 wherein:
said flexible connecting member includes a belt

6. A deployable structure according to claim 1, wherein:
said first and second urging means each include a spring.

7. A deployable structure according to claim 6, wherein:
said first rolling rack includes a set of end rollers at said other end.

8. A deployable structure according to claim 7 wherein:
said first rolling segment includes engagement means conformed to capture said end rollers upon the translation thereof to said other end.

9. An articulated structure useful in moving a motorcycle mounted on a ramp through a doorway of a motor vehicle, comprising:
a source of rotary power deployed in said vehicle and provided with a spool assembly having a flexible belt wound thereon with the free end thereof connected to the front end of said ramp;
a rolling rack mounted generally longitudinally in said vehicle having one end thereof aligned for rolling translation adjacent said spool assembly and the other end aligned adjacent the lower edge of said doorway;
first urging means connected between said rolling rack and said vehicle for urging said rolling rack towards said doorway;
a first rolling segment mounted for rolling translation on said track said first rolling segment including a first and second end, said second end being aligned to extend said second end over said lower edge of said doorway upon the translation of said first rolling segment on said rolling rack;
second urging means operatively connected between for the rack and said first rolling segment for the advancement thereof to extend said second end over said lower edge of said doorway; and
a second rolling segment mounted for rolling translation between the first and second ends of said first rolling segment and for supporting said ramp thereon.

10. An articulated structure according to claim 9, wherein:
said first and second urging means each include a spring.

11. An articulated structure according to claim 10, wherein:
said first rolling rack includes a set of end rollers at said other end.

12. An articulated structure according to claim 11, wherein:
said first rolling segment includes engagement means conformed to capture said end rollers upon the translation thereof to said other end.

13. An articulated structure according to claim 9, wherein:
said other end of said ramp includes supporting rollers.

14. An articulated structure according to claim 14, wherein:
said first rolling rack includes a set of end rollers at said other end; and.
said first rolling segment includes engagement means conformed to capture said end rollers upon the translation thereof to said other end.

15. An articulated structure according to claim 14, wherein:
said motorcycle is releasably mounted on said ramp.

16. An articulated structure according to claim 15, wherein:
said first rolling segment is pivoted about said end rollers by the combined weight of said motorcycle and said ramp.

17. An articulated structure according to claim 16, wherein:
said source of rotary power includes an electric motor.

18. An articulated structure according to claim 17, wherein:
said electric motor is reversible in the rotation thereof.
